(19) United States
(12) Patent Application Publication
(10) Pub. No.: US 2006/0149954 A1
(43) Pub. Date: Jul. 6, 2006

(54) Apparatus and method for accommodating different central processing units in a computer

(76) Inventors: Matt Hageman, Fort Collins, CO (US); Bradley Scott Tanner, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/004,479

(22) Filed: Dec. 3, 2004

(51) Int. Cl. G06F 15/177

(52) U.S. Cl. 713/1

(57) ABSTRACT

A computer may use either of two types of central processing units having similar boot vectors by detecting which type of processor is present and dynamically adjusting, if necessary, the initialization-instruction address signals associated with one or the other type. Detecting which type of processor is present may be performed before boot time, while the computer is in a standby power state, or while system power is turned on but before the first initialization instruction has been fetched.

### FIELD OF THE INVENTION

The present invention relates generally to computers and more specifically to techniques for accommodating different kinds of central processing units in a single computer.

### BACKGROUND OF THE INVENTION

As computer architectures evolve, a situation can arise in which different types of central processing units (CPUs) can be used interchangeably in the same computer. For example, a reduced-instruction-set (RISC) processor may be designed to replace a complex-instruction-set (CISC) processor in the same architecture. If the two processors are designed to be pin-compatible with the same socket, either processor may, in principle, be deployed in the system. A difficulty arises, however, where the two processors, though they have completely different machine languages, have boot vectors that are nearly identical. For example, the two boot vectors may lie within the same address block of the firmware containing initialization instructions (e.g., ROM BIOS). Since the initialization instructions supplied by the CPU manufacturer must remain contiguous, switching processors (i.e., replacing one type of processor with a different type that is pin compatible) poses a challenge. One solution is to switch the firmware whenever the CPU is switched. Another solution is to store the initialization instructions in a rewritable memory (e.g., a flash memory) that can be rewritten whenever the CPU is switched.

It is thus apparent that there is a need in the art for an improved apparatus and method for accommodating different CPUs in a computer.

### BRIEF DESCRIPTION OF THE DRAWINGS

FIG. 1 is a functional block diagram of a computer in accordance with an illustrative embodiment of the invention.

FIG. 2 is a functional block diagram of a computer in accordance with another illustrative embodiment of the invention.

FIG. 3 is an illustration of address adjustment logic in accordance with an illustrative embodiment of the invention.

FIG. 4 is a flowchart of a method for accommodating different types of CPUs in a computer in accordance with an illustrative embodiment of the invention.

FIG. 5 is a flowchart of a method for accommodating different types of CPUs in a computer in accordance with another illustrative embodiment of the invention.

### DETAILED DESCRIPTION OF THE INVENTION

Different central processing units (CPUs) having similar boot vectors may be accommodated in a single computer by storing the initialization instructions for the different types of processors disjointly in a memory, detecting which type of CPU is present in the system, and, where necessary, dynamically altering initialization instruction address signals to point to the corresponding set of initialization instructions for the socketed CPU.

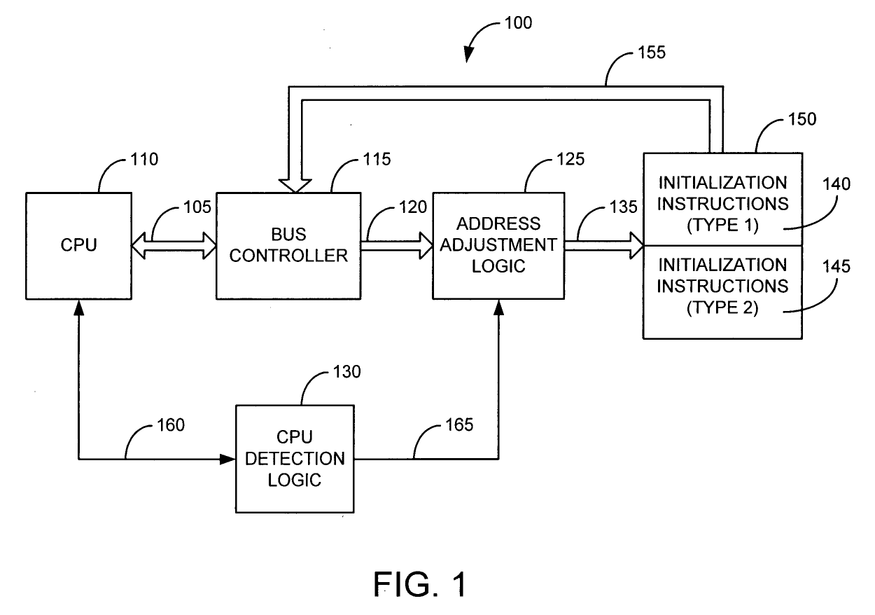

FIG. 1 is a functional block diagram of a computer 100 in accordance with an illustrative embodiment of the invention. Front-side (high-speed) bus 105 may connect CPU 110 with bus controller 115. In this particular embodiment, CPU 110 may be either of two different types of processors: (1) a Precision-Architecture Reduced-Instruction-Set (PA-RISC) processor or (2) an Intel-Architecture (IA-64) processor. The two types of processors are assumed to have boot vectors (the address in memory of the first initialization instruction) that lie within the same address block (e.g., within the same sector of a flash memory that contains initialization instructions). Without loss of generality, a PA-RISC processor will, throughout this Detailed Description, be called a “Type 1” processor, and an IA-64 processor will be called a “Type 2” processor. These designations are arbitrary and are used purely for convenience and clarity in this Detailed Description.

One output of bus controller 115 may be address bus 120, whose initialization instruction address signals (“address signals”) are fed to address adjustment logic 125. (For clarity, other connections between bus controller 115 and I/O and memory have been omitted in FIG. 1.) Address adjustment logic 125, if so directed by CPU detection logic 130, dynamically alters address signals 120 to produce altered address signals 135. Otherwise, address signals 120 are passed through address adjustment logic 125 unchanged, and, in that case, address signals 135 are equivalent to address signals 120. In either case, address signals 135 fetch the appropriate initialization instructions (140 or 145) for CPU 110 from memory 150, and the initialization instructions 140 or 145 may be fed to CPU 110 via data bus 155 and bus controller 115. Memory 150 may be, for example, read-only memory (ROM) or flash memory. As indicated in FIG. 1, initialization instructions 140 and 145 for Type-1 and Type-2 processors, respectively, may be stored disjointly in memory 150. That is, they may be stored in separate portions of memory 150 that do not overlap.

CPU detection logic 130 can detect the type of CPU 110 by reading the onboard ROM of CPU 110 (not shown in FIG. 1) over Inter-Integrated Circuit (I²C) bus 160. CPU detection logic 130 may, via control signal 165, control the operation of address adjustment logic 125 in accordance with the detected type of CPU 110. For example, CPU detection logic 130 may direct address adjustment logic 125 to pass through unaltered address signals 120 pointing to initialization instructions (Type 2) 145, if CPU 110 is a Type-2 processor, and CPU detection logic 130 may direct address adjustment logic 125 to adjust address signals 120 to point to initialization instructions (Type 1) 140, if CPU 110 is a Type-1 processor. Those skilled in the art will recognize that which processor's (Type 1 or Type 2) address signals are adjusted is arbitrary. In other embodiments, for example, address signals 120 associated with the Type-1 processor may be passed through unchanged, and address signals 120 associated with the Type-2 processor may be altered to point to initialization instructions (Type 2) 145.

CPU detection logic 130 may be implemented in a variety of ways. For example, in one embodiment, CPU detection logic 130 may comprise a baseboard management controller (BMC). In a different embodiment, CPU detection logic 130 may comprise a pin that is used by one type of processor but not by another. In general, the function performed by CPU detection logic 130 is to detect the type of CPU 110 and to inform address adjustment logic 125.

In some embodiments, CPU detection logic 130 operates in a standby power (low-power) condition while the main system power of computer 100 is turned off. In that way, CPU 10 may be identified before main system power is turned on and initialization instructions 140 or 145 are fetched from memory 150 to boot up computer 100. In other embodiments, CPU detection logic 130 may detect the type of CPU 110 while main system power is turned on but before the first initialization instruction has been fetched from memory 150.

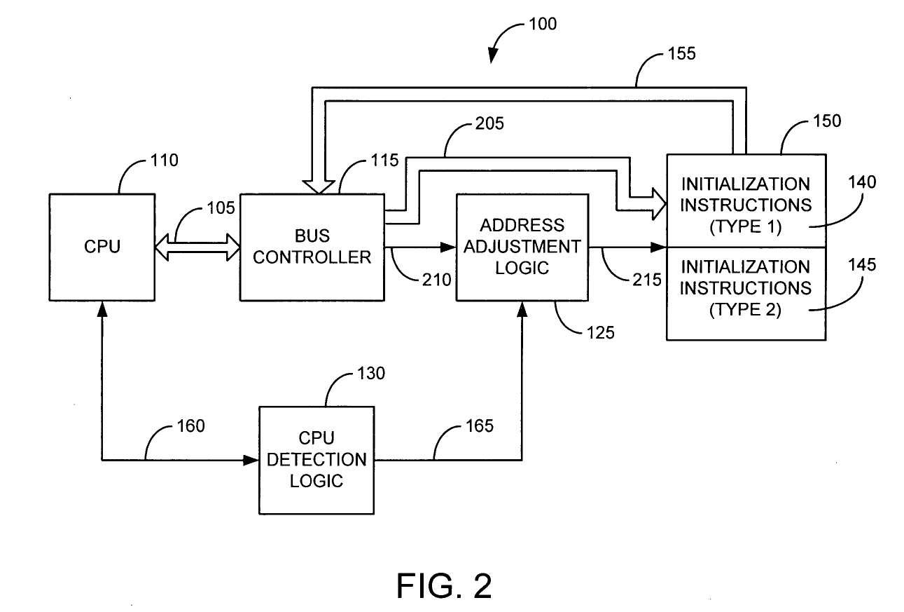

FIG. 2 is a functional block diagram of computer 100 in accordance with another illustrative embodiment of the invention. In this particular embodiment, address signals 120 are split into low-order bits 205 and most-significant bit (MSB) 210. Low-order bits 205 may be routed directly to memory 150, and MSB 210 may be input to address adjustment logic 125. Address adjustment logic 125 may dynamically alter address signals 120 for a Type-1 processor by inverting the logical state of MSB 210 to produce altered MSB 215. For example, if address signals 120 comprise a 23-bit address bus, inverting MSB 210 when it equals logic “1” shifts address signals 120 down in memory by 4 MB. Therefore, initialization instructions (Type 1) 140 can be stored 4 MB below the normal address vector associated with a Type-1 processor. In the case of a Type-2 processor, address adjustment logic 125 may simply pass MSB 210 through unaltered (i.e., MSB 215 is the same as MSB 210).

FIG. 2 merely illustrates one approach to altering address signals 120 in address adjustment logic 125. Many alternative approaches to accomplishing the adjustment of address signals 120 are possible, and all such approaches are deemed to be within the scope of the invention as claimed. For example, an offset could be added to or subtracted from address signals 120 using an adding circuit instead of inverting MSB 210.

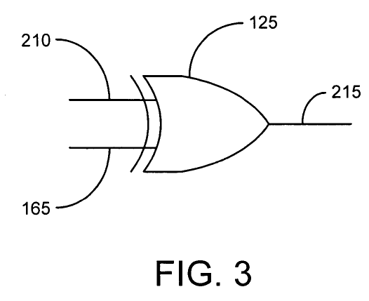

FIG. 3 is an illustration of address adjustment logic 125 in accordance with an illustrative embodiment of the invention. FIG. 3 is an example of a circuit for implementing address adjustment logic 125 in the context of the embodiment discussed in connection with FIG. 2. In that embodiment, address adjustment logic 125 behaves functionally like an exclusive-or (XOR) gate. MSB 210 and control signal 165 are the inputs, and (potentially) altered MSB 215 is the output. If control signal 165 is logic “0” (Type 2 processor), MSB 215 will equal MSB 210. If control signal 165 is logic “1” (Type 1 processor), MSB 215 will be the logical inverse of MSB 210, shifting address signals 120 to point to initialization instructions (Type 1) 140. The functionality of address adjustment logic 125 may be implemented, for example, in a field-programmable gate array (FPGA).

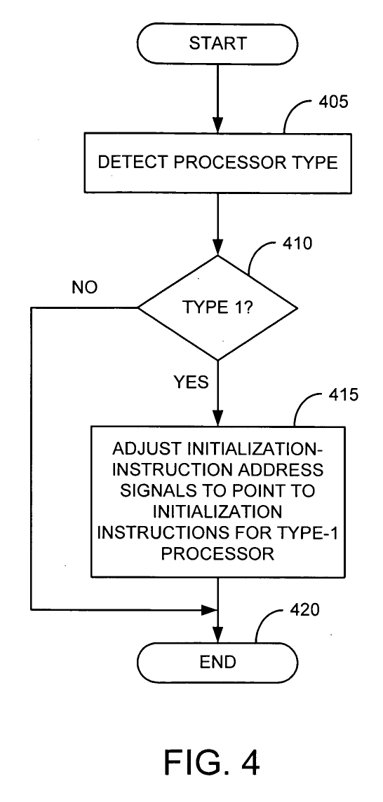

FIG. 4 is a flowchart of a method for accommodating different types of CPUs in a computer 100 in accordance with an illustrative embodiment of the invention. At 405, CPU detection logic 130 detects the type of CPU 110 and sets control signal 165 to the corresponding state. Once set, the state of control signal 165 may be maintained throughout the boot-up process (i.e., until all initialization instructions 140 or 145 have been fetched). As mentioned above, this may be done while computer 100 is in a low-power state with main system power switched off or after main power has been switched on but before the first initialization instruction is fetched from memory 150. At 410, appropriate action is taken according to the detected type of CPU 110. Without loss of generality, if CPU 110 is a Type-1 processor, address signals 120 may be adjusted by address adjustment logic 125, at 415, to point to initialization instructions (Type 1) 140, and the process may terminate at 420. Otherwise, if CPU 110 is a Type-2 processor, address adjustment logic 125 need not take any action at 410.

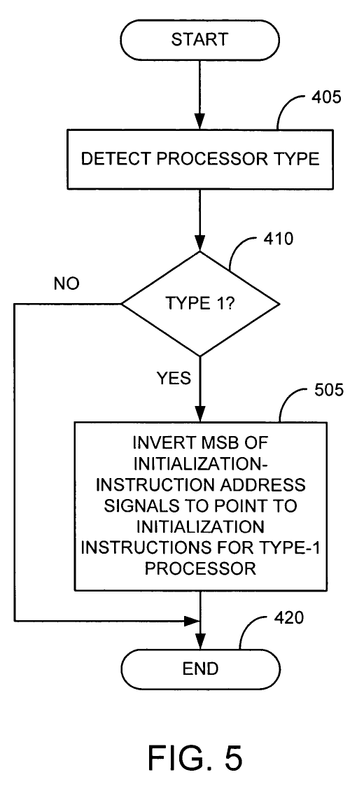

FIG. 5 is a flowchart of a method for accommodating different types of CPUs in a computer 100 in accordance with another illustrative embodiment of the invention. FIG. 5 corresponds to the embodiment discussed in connection with FIG. 2. At 505, address adjustment logic 125 may invert MSB 210 to shift address signals 120 to point to initialization instructions (Type 1) 140, if CPU 110 is detected to be a Type-1 processor at 410. Otherwise, address adjustment logic 125 passes through MSB 210 unaltered, and initialization instructions (Type 2) 145 are instead accessed, if CPU 110 is detected to be a Type-2 processor at 410.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A computer, comprising:
a central processing unit that is one of a first type and a second type compatible with a socket, the first and second types having boot vectors that lie within a common address block;
a memory containing disjoint first and second sets of initialization instructions for the first and second types, respectively;
CPU detection logic that determines the type of the central processing unit; and
address adjustment logic that adjusts initialization-instruction address signals to point to the first set, when the CPU detection logic determines that the central processing unit is of the first type.

2. The computer of claim 1, wherein the CPU detection logic is configured to determine the type of the central processing unit during a standby power condition while main system power is turned off.

3. The computer of claim 1, wherein the CPU detection logic is configured to determine the type of the central processing unit while main system power is turned on but before a first initialization instruction has been fetched.

4. The computer of claim 1, wherein the CPU detection logic is configured to determine the type of the central processing unit by reading an onboard ROM of the central processing unit.

5. The computer of claim 1, wherein the CPU detection logic comprises a baseboard management controller.

6. The computer of claim 1, wherein the address adjustment logic is configured to invert a bit of the initialization-instruction address signals, when a control signal from the CPU detection logic is in a first state corresponding to the first type, and the address adjustment logic is configured to pass through the bit, when the control signal is in a second state corresponding to the second type.

7. The computer of claim 6, wherein the bit is a most significant bit of the initialization-instruction address signals.

8. The computer of claim 1, wherein the first type is PA-RISC and the second type is IA-64.

9. The computer of claim 1, wherein the address adjustment logic comprises a field-programmable gate array.

10. A computer, comprising:
processing means that is one of a first type and a second type compatible with a socket, the first and second types having boot vectors that lie within a common address block;
means for storing disjoint first and second sets of initialization instructions for the first and second types, respectively;
means for detecting the type of the processing means; and
means for adjusting initialization-instruction address signals to point to the first set, when the means for detecting the type of the processing means determines that the processing means is of the first type.

11. The computer of claim 10, wherein the means for detecting the type of the processing means is configured to detect the type of the processing means during a standby power condition while main system power is turned off.

12. The computer of claim 10, wherein the means for detecting the type of the processing means is configured to detect the type of the processing means while main system power is turned on but before a first initialization instruction has been fetched.

13. The computer of claim 10, wherein the means for detecting the type of the processing means is configured to detect the type of the processing means by reading an onboard ROM of the processing means.

14. The computer of claim 10, wherein the means for detecting the type of the processing means comprises a baseboard management controller.

15. The computer of claim 10, wherein the means for adjusting is configured to invert a bit of the initialization-instruction address signals, when a control signal from the means for detecting the type of the processing means is in a first state corresponding to the first type, and the means for adjusting is configured to pass through the bit, when the control signal is in a second state corresponding to the second type.

16. The computer of claim 15, wherein the bit is a most significant bit of the initialization-instruction address signals.

17. The computer of claim 10, wherein the first type is PA-RISC and the second type is IA-64.

18. The computer of claim 10, wherein the means for adjusting comprises a field-programmable gate array.

19. A method for accommodating different types of central processing units in a single computer, comprising:
detecting that a central processing unit is one of a first type and a second type, the first and second types having boot vectors that lie within a common address block; and
altering initialization-instruction address signals associated with the first type to point to a first portion of a memory containing initialization instructions, when the central processing unit is detected to be of the first type, the first portion being disjoint from a second portion of the memory, the second portion being associated with the second type.

20. The method of claim 19, wherein detecting that a central processing unit is one of a first type and a second type is performed while the computer is in a low-power state and main system power is switched off.

21. The method of claim 19, wherein detecting that a central processing unit is one of a first type and a second type is performed while main system power is turned on but before a first initialization instruction has been fetched.

22. The method of claim 19, wherein detecting that a central processing unit is one of a first type and a second type comprises reading an onboard ROM of the central processing unit.

23. The method of claim 19, wherein adjusting initialization-instruction address signals comprises inverting a bit of the initialization-instruction address signals.

24. The method of claim 23, wherein the bit is a most significant bit of the initialization-instruction address signals.

25. The method of claim 19, wherein the first type is PA-RISC and the second type is IA-64.
